(19) United States
(12) Patent Application Publication
(10) Pub. No.: US 2005/0003333 A1
(43) Pub. Date: Jan. 6, 2005

(54) Method and a system for teaching a target of instruction

(76) Inventors: Yevsey Zilman, (US); Olga Safonova, (US)

Correspondence Address: Edward D. Pergament, 13 Gulf Road, East Brunswick, NJ, 08816, US

(21) Appl. No.: 10/878,158

(22) Filed: Jun. 28, 2004

Related U.S. Application Data
(60) Provisional application No. 60/484,634, filed on Jul. 3, 2003.

(51) Int. Cl. G09B 19/00; G09B 19/06; G09B 19/08; G09B 5/00

(52) U.S. Cl. 434/156; 434/157

(57) ABSTRACT

There is provided a method for teaching a target of instruction to a person, the method including: exposing the person to at least one language unit in a mode of exposure intended for subconscious perception, wherein the person is simultaneously exposed to a pictorial representation of the language unit and its language equivalent; and subsequently exposing the person to the pictorial representation of the language unit in a mode of exposure intended for conscious perception. Various embodiments and variants are provided. A computer readable memory medium and a computer system implementing the method are also provided.

### CROSS-REFERENCE TO RELATED APPLICATION

This patent application claims the benefit of the filing date of the U.S. Provisional Application No. 60/484,634, filed Jul. 3, 2003, the disclosure of which is hereby incorporated by reference in its entirety.

### FIELD OF THE INVENTION

The present invention relates to the field of education and instruction.

### BACKGROUND OF THE INVENTION

Methods of teaching a given subject of instruction to students are numerous and extensively discussed in the literature. For example, the literature on the methods of learning foreign languages lists various methods, beginning with the translation method used traditionally to newer methods, such as the audio-lingual method, the direct method, and the total immersion method.

The translation method is based on memorization of complicated rules, logical analysis of the language, explanations in the native language, and conscious application of the rules. In the translation method, students attempt to formulate the sentence in the native language, and then translate it to a foreign language, trying to comply with the grammatical structure and rules. Although this method is notoriously inefficient, it is the most widespread method used in most schools and colleges.

Learning a foreign language as an adult is particularly difficult task for most people. Prevailing methods of language instruction share a common feature, i.e., a direct connection between the native language and a foreign language. Even in cases when instructions are given in a foreign language (e.g., direct method or total immersion method), adults in many cases subconsciously translate foreign language into their native language, thus substantially reducing the learning efficiency. The newer methods of learning a language also have various drawbacks.

Accordingly, there is a need for new methods of teaching a subject of instruction, such as a language.

### SUMMARY OF THE INVENTION

In accordance with one aspect, the invention provides a method for teaching a target of instruction to a person, the method including:
exposing the person to at least one language unit in a mode of exposure intended for subconscious perception, wherein the person is simultaneously exposed to a pictorial representation of the language unit and its language equivalent; and
subsequently exposing the person to the language unit in a mode of exposure intended for conscious perception. Various embodiments and variants are provided.

In accordance with another aspect, the invention provides a method for teaching a target language of instruction to a person having a home language, the method including:
a. exposing the person to at least one base set of language units in a mode of exposure intended for subconscious perception, wherein, for each language unit in the base set, the person is simultaneously exposed to a pictorial representation of the language unit and its language equivalent in the target language; and
b. subsequently exposing the person to the pictorial representation of the language unit and its language equivalent in the home language in a mode of exposure intended for conscious perception. Various embodiments and variants are provided.

In accordance with yet another aspect, the invention provides, in a computer system, a method for teaching a target of instruction to a person, the method including:
i) presenting the person with static display of a pictorial representation of a language unit thus communicating a challenge that requires the person to translate the pictorial representation into its language equivalent;
ii) receiving the translation from the person in response to the challenge; and
iii) providing the person with means to ascertain whether the person comprehended the challenge. Various embodiments and variants are provided.

In accordance with yet another aspect, the invention provides a computer readable memory medium containing instructions for controlling the operation of a computer processor in a computer system for teaching a target of instruction to a person, the computer system including a display device, the computer system having
a) stored data of a first series of visual cards, one visual card for each language unit that belongs to at least one base set of language units, wherein each of the visual cards contains a pictorial representation of the language unit and its language equivalent;
b) stored data of a second series of visual cards, at least one for each language unit that belongs to at least one subset of the base set of language units, wherein the second series contains at least the pictorial representation of the language unit; and
c) instructions for controlling the operation of the computer processor to perform the steps of:
i) retrieving the stored data of the first series of visual cards;
ii) displaying the first series of visual cards one after another in a predetermined sequence on the display device at a speed intended for subconscious perception by the person;
iii) retrieving the stored data of the second series of visual cards; and
iv) displaying the second series of visual cards one after another in a second predetermined sequence on the display device at a speed intended for conscious perception by the person. Various embodiments and variants are provided.

### DESCRIPTION OF DRAWINGS

FIG. 1A is a flow chart of a method in accordance with an aspect of the invention;

FIG. 1B is a flow chart of a method in accordance with an aspect of the invention;

FIG. 2 is an exemplary block diagram of a system in accordance with one aspect of an invention;

FIGS. 3A-3B show a Home Screen for ZS Supertutor™, a particular computer program in accordance with an embodiment of the invention;

FIG. 4 shows a Lesson Screen for ZS Supertutor™, a particular computer program in accordance with an embodiment of the invention;

FIG. 5 shows another Lesson Screen for ZS Supertutor™, a particular computer program in accordance with an embodiment of the invention;

FIG. 6A shows an example of the visual card A in accordance with one variant of the invention;

FIG. 6B shows a display flow diagram for a first series of visual cards in accordance with one embodiment of the invention;

FIG. 7 shows the entry into the Operation 2 for ZS Supertutor™, a particular computer program in accordance with an embodiment of the invention;

FIG. 8A shows examples of the visual cards A and B in accordance with one variant of the invention;

FIG. 8B shows a display flow diagram for a second series of visual cards in accordance with one embodiment of the invention;

FIG. 9A shows examples of the visual cards C, D, and E in accordance with one variant of the invention;

FIG. 9B shows a display flow diagram for a third series of visual cards in accordance with one embodiment of the invention;

FIG. 10A shows the entry into the Operation 4 for ZS Supertutor™, a particular computer program in accordance with an embodiment of the invention;

FIG. 10B shows the Operation 4 Screen for ZS Supertutor™, a particular computer program in accordance with an embodiment of the invention;

FIG. 10C shows a variant of a phonetics screen for ZS Supertutor™, a particular computer program in accordance with an embodiment of the invention;

FIG. 11 shows the entry into the Operation 5 for ZS Supertutor™, a particular computer program in accordance with an embodiment of the invention;

FIGS. 12A-12B show an example of an exercise of the Operation 5 for ZS Supertutor™, a particular computer program in accordance with an embodiment of the invention;

FIGS. 13A-13D show another example of an exercise of the Operation 5 for ZS Supertutor™, a particular computer program in accordance with an embodiment of the invention;

FIG. 14 shows another example of an exercise of the Operation 5 for ZS Supertutor™, a particular computer program in accordance with an embodiment of the invention.

### DESCRIPTION OF THE PREFERRED EMBODIMENTS

For the purposes of the present invention, various terms used herein are defined as follows.

The term “target of instruction” is used to denote any subject that a student may be able to learn using the general principles embodied in the appended claims. Non-limiting examples of targets of instructions include a foreign language, SAT, or similar test preparation, and so on.

The term “target language” is used herein to denote any language of instruction for which the present invention(s) may be used. The person studying the target language (also referred to herein as “a student”) may have various degrees of familiarity with the target language.

The term “home language” is used herein to denote any language substantially familiar to a person using the present invention(s). The home language may be the same as or different than the target language.

The terms “exposing” and “exposure” with respect to the person using the present invention means providing information input, of any type, to the person.

The term “language unit” means any type of subject matter that may be described by using a language. The term “representation” refers to any form by way of which a language unit may be presented to a person to expose the person to the language unit; which form may lead to the person's perception, either conscious or subconscious, of the language unit. For example, a “representation” of the language unit may be visual or audio. The term “language unit” is not limited to a language-based representation of a given subject matter. In a non-limiting example, a tree may be represented by a picture of the tree, or the sounds denoting the tree in any language, or a written word “tree” comprised of written letters.

The term “base set of language units” means a predetermined compilation of a number of language units to which the person using the invention(s) is exposed. The inventors contemplate the use of a single base set of language units, as well as the use of multiple base sets of language units in a course of instruction. The term “predetermined” with reference to a number, quantity or order of display means that the number, quantity or order of display had been set with certainty before the use of the method or a system of the invention by the student had began. The term “predetermined” does not mean that the number, quantity or order of display cannot be varied among fixed value levels.

The terms “subset,” “subset of language units,” and “subset of said at least one base set” are used interchangeably in the disclosure and the claims, and mean a compilation of a plurality of language units, each of which is also included in the base set. The number of the language units in the subset may be the same as or smaller than the number of language units in the base set.

The expression “one language unit after another” means a person who uses the invention is sequentially exposed to the language units in the set. The person may be exposed to one or more language units at a time, but there exist a sequence in which the exposure occurs.

The term “subconscious perception” with respect to exposure of a person using the invention(s) means that the person is exposed to language unit(s) in a manner in which an average person cannot be expected to perceive and internalize their meaning using the conscious thought process. While the invention is not limited to any specific theory, it is believed that there are modes of exposure of a person to informational input in which the person's subconscious perceives and stores the information, at least partially and/or at least for a limited period of time, even though the information input could not be understood and internalized using the conscious thought process.

The term “conscious perception” with respect to exposure of a person using the invention(s) means that the informational input is provided to the person in a manner in which an average person is expected to understand and internalize it using the conscious thought process.

The term “pictorial representation” with respect to a language unit means a visual representation of the subject matter of the language unit using any visual means other than letters-based text. In the description of embodiments, the term “picture” may be used instead for convenience.

The term “language equivalent” with respect to a language unit means a representation of the language unit using any mode of expressing the word-based meaning of the language unit in any language. Non-limiting examples of language equivalents include audio sounds denoting the language unit and a written text denoting the language unit in any language.

The term “textual representation” with respect to a language unit means a visual representation of the subject matter of the language unit using letters-based text in any language.

The terms “simultaneously exposed” or “simultaneous exposure” with respect to a language unit means substantially simultaneously providing the person with informational input of two or more different representations of the same language unit.

The expression “exposed to an audio form of the language equivalent” with respect to a language unit means exposing the person using the invention(s) to audio sounds containing the language unit's meaning in any language.

The expression “exposed to a visual form of the language equivalent” with respect to a language unit means exposing the person using the invention(s) to the language equivalent of the language unit via visual perception.

The terms “displaying” and “display” mean showing the subject matter to a person using the invention via any method or device, non-limiting examples of which include a computer monitor, TV-based display screen, Personal Digital Assistant, Mobile Telephone Screen, and the like.

The term “visual card” means any discreet visual representation of a language unit. The particular meaning used in the description of embodiments refers to discreet visual panes designed to be stored in electronic form. However, since the method of the invention may be implemented through a variety of technological platforms, the meaning is not intended to be limited to one used in the description of embodiments. A visual card may contain one visual representation of the language unit or a plurality of visual representations.

The term “speed of display” with respect to visual cards means the rate with which visual cards are changing while being displayed to a student in a series. For example, if 60 visual cards are shown, one at a time, during the period of 60 seconds, the speed of display is 1 card/second.

The term “alternate” with respect to visual cards means that the display of one type of visual cards is alternating with the display of another type of visual cards. In a non-limiting example, a series of visual card may begin with display of a visual card of a first type, followed by display of a visual card of a second type, followed by display of a visual card of the first type, and so on.

The term “computer system” means any device utilizing processor-based computing. Non-limiting examples of computer systems include personal computer, a distributed computing system, a dedicated microprocessor based device, a PDA, a Mobile Phone having a processor, a server-based system, and so on. The method(s) and system(s) of the invention are meant to encompass any type of implementation methodology.

It is believed that memorization is an active process which involves perception of the informational input and its accumulation for subsequent reproduction and internalization of the information into already-developed system of associative thought-relationships. In early childhood, the principal mechanism of internalization is believed to be the direct memorization. In contrast, later in life a greater role is played by indirect memory.

The learning of a language is a good example. Typically, students first formulate the sentence in the native language, then try to translate it quickly into a foreign language whereas they try to perform a grammatical analysis before attempting to speak the construed sentences in a foreign language. Therefore, there is an objective barrier to learning a language as an adult—the adult find it nearly impossible to avoid subconsciously translating from the home language to the language being learned.

The inventors recognized a need for new methods for teaching a target of instruction. For example, the inventors recognized the need for a method of learning a language that does not involve direct translation.

Learning of a language inevitably involves perceiving and memorizing a multiplicity of language units in the form words, expressions, sentences, etc. in the target language, used by the native speakers to reflect the reality of the world in language terms. While the invention is not limited to any scientific theory, the inventors believe that, while learning a language, it is important to avoid the direct connection between the home language and the target language. It may be particularly important to do so in the early period of learning a language when constant reference to the home language may limit the student's ability to acquire the vocabulary of the target language. In this regard, the inventors recognized that a pictorial representation may serve as a vehicle for breaking such direct connection between the home and target languages, while at the same time still allowing the student to internalize the language units in the target language using the student's knowledge of the home language without which it may not be possible to learn the language at all.

The inventors further recognized that a pictorial representation of a language unit associated with its target language equivalent may be used to teach the target language without simultaneous use of home language equivalent. The absence of simultaneous exposure to both target language and home language equivalents of a language unit is believed to provide basis for associative memorization of the language units in the target language independently of the home language, and their subsequent use by the student.

Again, while the invention is not limited to any scientific theory, the inventors also recognized that the necessary language units (each as a pictorial representation associated with its target language equivalent) may be “loaded” into a mind of a student at the outset of language studies by using the student's sub-conscious perception ability.

Subsequently, the “loaded” pictorial representation(s) can be used to transpose the language unit from the sub-consciousness. In this transposition or actuation process, the pictorial representation of the language unit is associated with its home language equivalent, preferably, again without direct connection between the home and target language. Preferably, the subsequent transposition of a language unit into the home language involves retrieval from the person's sub-consciousness in the mode suitable for conscious perception.

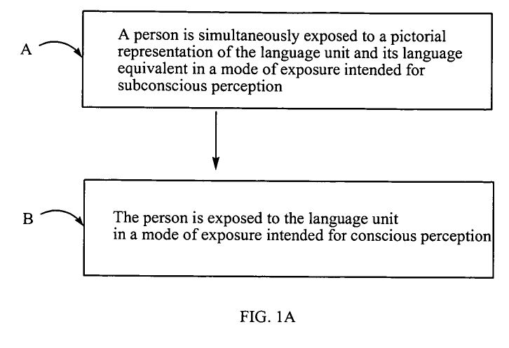

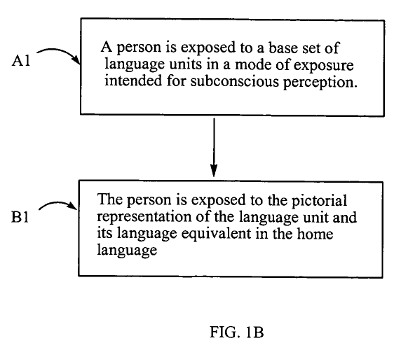

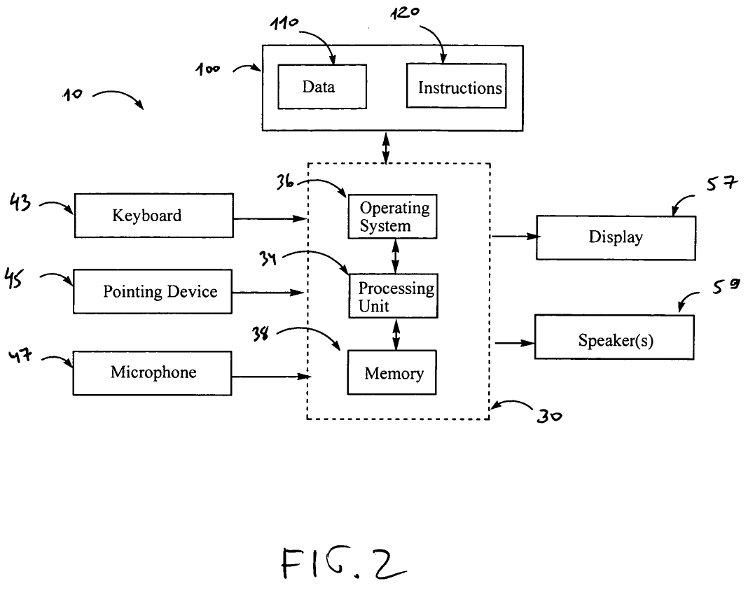

FIGS. 1A and 1B illustrate the outline of the method according to some of the aspects of the invention. The invention is by no means limited to methods of teaching a language. FIG. 1A illustrates the general principle of the method of teaching any target of instruction in accordance with one aspect of the invention. In Step A, the person is simultaneously exposed to a pictorial representation of a language unit and its language equivalent in a mode of exposure intended for subconscious perception. Subsequently, in Step B, the person is exposed to the language unit in a mode of exposure intended for conscious perception. The method of this aspect of the invention may be used, for example, for preparation for various standardized tests (e.g., SAT, LSAT, MCAT, etc.), as well as for learning a target language.

A particular aspect of the invention, namely, the method of teaching a target language of instruction to a person having a home language is illustrated in FIG. 1B. Referring to FIG. 1B, a person leaning the language is first exposed to a base set of language units in a mode of exposure intended for subconscious perception (Step A1). The base set of language units represents a group of language units to be learned for a given purpose, for example a group of language units to be learned in a course of study or in a given lesson. In Step A1, each language unit in the base set is simultaneously represented by its pictorial representation and its language equivalent in the target language. For example, a tree can be represented by a picture of a tree and the word “tree” in the target language. In this manner, an association is created between the picture and its language equivalent in the target language. When the student is exposed to the entire base set in a mode intended for subconscious perception, all language units in the base set are “loaded” into the student's sub-consciousness. Since the exposure of Step A1 is not intended for conscious perception and learning, large quantity of language units may be included in the base set.

One non-limiting example of implementation of the subconscious perception mode is displaying the pictorial representation of the language unit for very short time length. It is believed that when the length of display varies from 40 to 80 milliseconds, the exposed person is unable to perceive the content of the display consciously, and the subconscious perception results. An example of implementation of the subconscious perception mode is disclosed, for example, in Russian Federation Patent No. RU 2124233, the disclosure of which is incorporated herein by reference only to show the state of the art.

The pictorial representation may be presented on a visual card. In this manner, the student may be exposed to one visual card at a time, or more than one visual card, as long as the duration of display for any visual card is suitable for subconscious perception. Likewise, there are different ways of associating the pictorial representation of a language unit with its target language equivalent. Thus, the target language equivalent may be displayed textually on the same frame as the pictorial representation. Also, the target language equivalent may be played in audio form at the same time as the frame with the pictorial representation is displayed.

The preferred mode of implementation for the subconscious perception mode involves displaying a series of visual cards in a series one after another at high speed of change, each visual card simultaneously displaying a pictorial representation and a target language textual representation of the same language unit. Preferably, the series has one visual card per language unit in the base set. When the speed or display is sufficiently high, conscious perception is not possible. At certain speed of changing display, the so-called 25^{th} frame effect is achieved: the information shown in the changing visual cards is perceived subconsciously. The necessary speed of display is believed to range from 12 to 25 frames per second. The student may be exposed to the base set once, twice, or any number of times before the Step B1.

In Step B1 (FIG. 1B), the student is exposed to at least one pictorial representation of a language unit previously included in Step A1, and its language equivalent in the home language. In this Step, simultaneous exposure to the pictorial representation of the language unit and its home language equivalent is not required, but may be used. When the pictorial representation of a language unit is displayed, it is believed the student will attempt to retrieve the associated target language equivalent from the sub-consciousness. In the prior example with the tree, while the student is not expected to know the target language, the student would be able to recognize the picture of the tree and would be likely to associate the target language equivalent with the home language equivalent without direct translation. Furthermore, the student's knowledge of the home language would be associated with the pictorial representation of tree rather than with the target language equivalent.

In Step B1, the student may be exposed to a subset of language units which were previously included in the base set. The number of language units in the subset may be smaller than or the same as the number of language units in the base set.

Preferably, the student is exposed to the subset of the base set in a mode of exposure intended for conscious perception. Any method of exposure suitable for conscious perception may be used. For example, the pictorial representation of the language unit may be displayed visually alone with subsequent exposure to the home language equivalent, or the pictorial representation of the language unit and its home language may be displayed simultaneously. The student may be exposed to the home language equivalent in any suitable manner, for example, visually or by audio.

Similarly to Step A1, the pictorial representation may be presented on a visual card. In this manner, the student may be exposed to one visual card at a time or more than one visual card at a time. Likewise, there are different ways of associating the pictorial representation of a language unit with its home language equivalent. Thus, the home language equivalent may be displayed textually on the same visual card as the pictorial representation. Also, the home language equivalent may be played in audio form at the same time or after the frame with the related pictorial representation is displayed. Or, the student may be presented with the pictorial representation and asked to carry out one or more manual learning tasks.

Step B1 may include one, two, three or more different distinct steps, including pre-set series of visual cards and/or manual learning tools. Again, preferably, the steps included in Step B1 rely on conscious perception by the student.

The preferred mode of implementation for Step B1 involves displaying a series of visual cards in a series one after another at a speed suitable for conscious perception. There may be one, two or more series of visual cards; the series may contain identical or different visual cards; the series may include same or different subsets of language units; and so on. Preferably, the series has one visual card per language unit in the base set.

The method(s) and/or systems of the invention may be implemented on various devices. One of the aspects of the invention is computer readable memory medium containing instructions for controlling the operation of a computer processor in a computer system for teaching a target language using the method described herein above. In another aspect, the invention provides a computer system that uses such computer readable memory medium.

Below, there is described a non-limiting embodiment, along with various alternatives, showing how the method of the invention is implemented on a personal computer platform. It should be understood that the invention is defined by the claims and should not limited to the described embodiment(s) and variant(s).

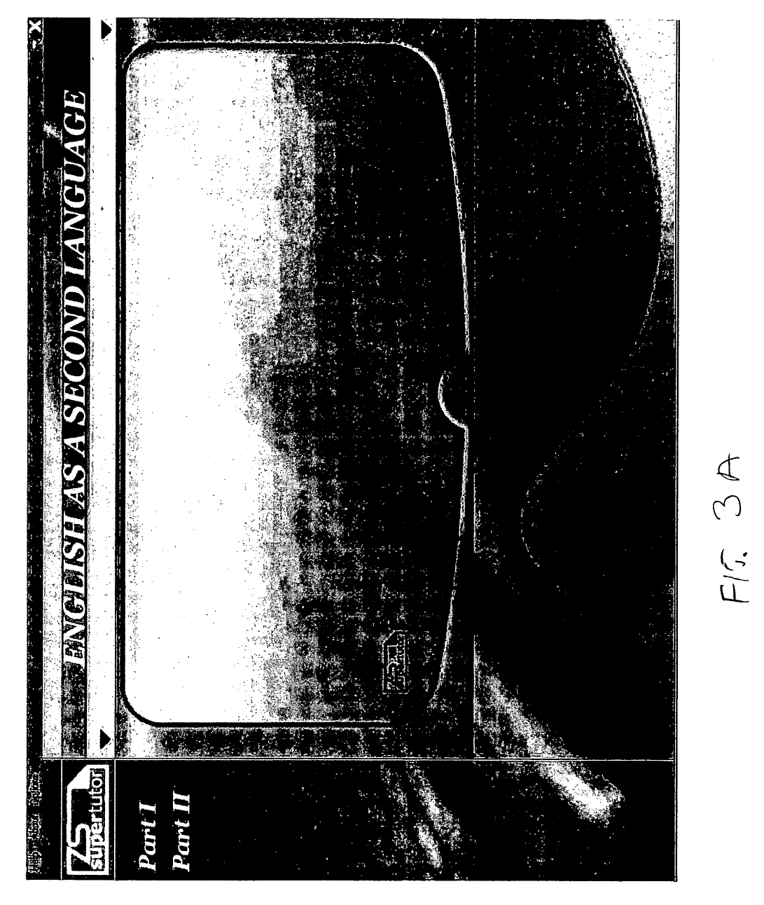

FIG. 2 shows an exemplary block diagram for a computer system 10 that may be used to implement the method of the invention. The computer system 10 includes a personal computer 30, a keyboard 43, a pointing device 45, a microphone 47, a video display 57, one or more internal or external speakers 59, and a software program 100.

The computer 30 may be a commercially available personal computer. The computer 30 typically includes a processing unit 34 controlled by an operating system 36. A memory 38 is connected to the processing unit 34. The memory 38 generally comprises, for example, random access memory, read only memory (ROM), magnetic storage media, such as a hard drive, floppy disk, or magnetic tape, and optical storage media, such as a CD-ROM. The operating system 36 may incorporate a windowing environment such as Microsoft Windows, Linux, or OS/2.

The keyboard 43, the pointing device 45, and the microphone 47 are input devices that allow the student to navigate various menus, issue commands, record audio and select answers. The pointing device 47 may be a computer mouse, a track ball, or other device that provides cursor control. The video display 57 and the speakers 59 serve to provide the student with visual or audio information. For example, the video display 57 and the speakers 59 may be used to expose the student to various language units (e.g., in accordance with the Steps A1 and B1 shown in FIG. 1B).

The program 100 includes data 110 and instructions 120. The data 110 and the instructions 120 may be stored for example, on the hard drive of the personal computer 30. The nature of the data 110 and instructions 120 will be well understood from the description of the operation and use of the particular embodiments of the system described below. The data 110 may include, for example, stored visual cards for display to the student in a predetermined sequence(s) (e.g., such visual cards as described below), stored pre-set exercises for students using the system, visual images of various program screens, various audio recordings, such as native speakers' audio recordings of various language units, exercises, and the like, and various musical recordings, and the like.

The instructions 120 manipulate the data 110. The instructions 120 may include the order of display, the speed of display, and so on. The programming methodology for the computer system and/or computer readable medium implementing the method described herein is conventional.

The preferred embodiment of the computer system and the computer readable medium implementing the method described herein is a computer program named ZS Supertutor™ and is described below. The example shown is for teaching English as Second Language to Russian speakers. Of course, the program can be utilized, with different pre-stored data, for any other target language and/or any other student group. A similar program may be based, for example, on a single language and used for in-depth language study or SAT instruction. In describing the ZS Supertutor™, various alternative variants and embodiments are sometimes noted. The absence of such note however should not be interpreted to indicate that no alternatives are contemplated. To the contrary, all alternative embodiments and variants, whether described or not, are contemplated as the invention as defined by the appended claims.

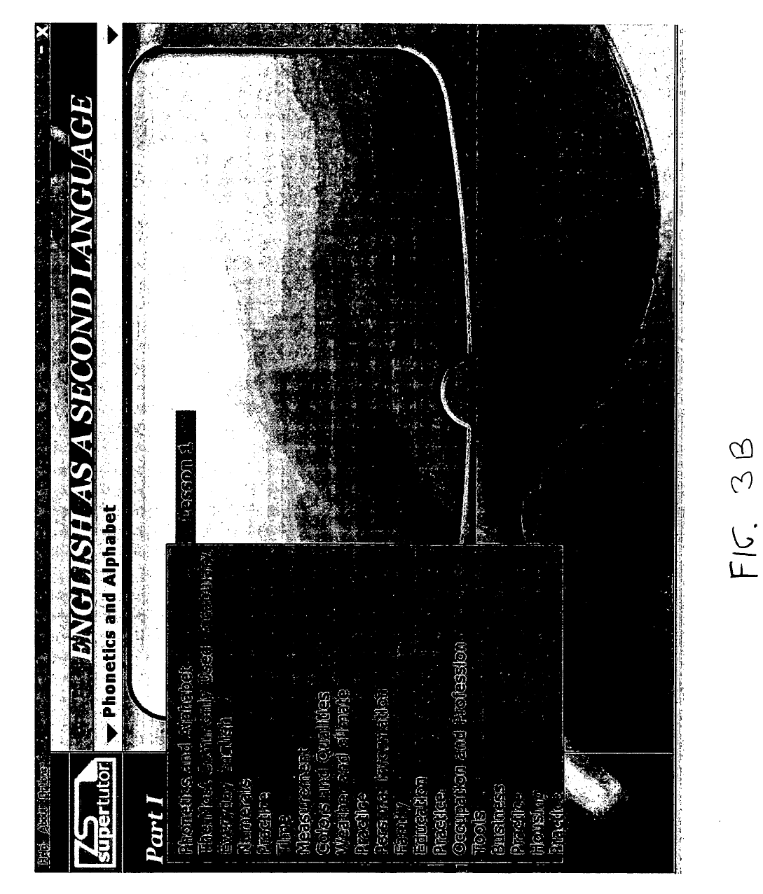

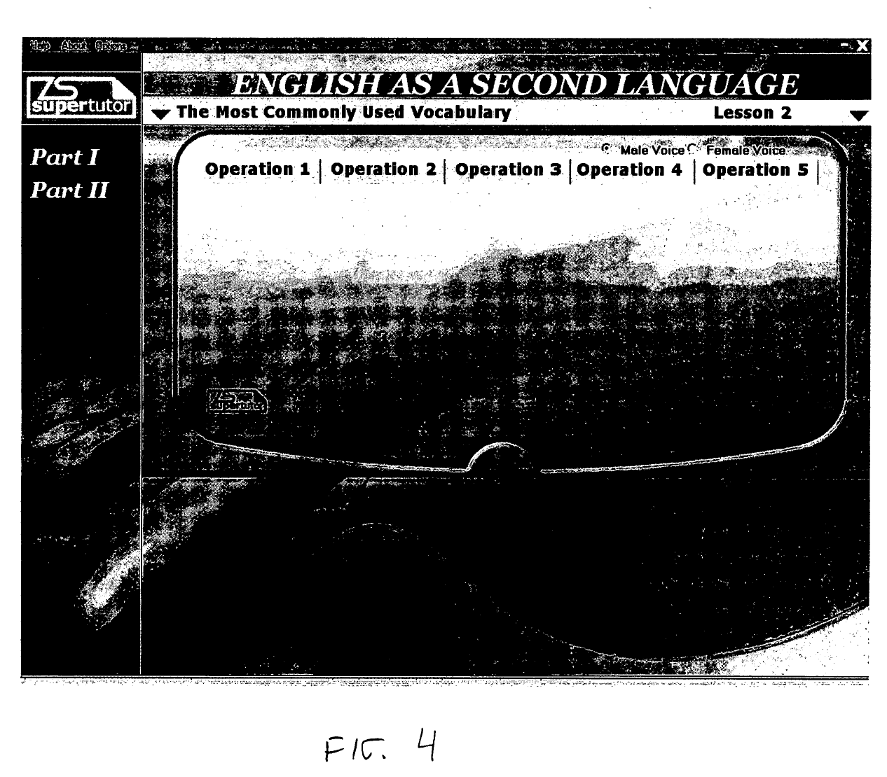

ZS Supertutor™ may be installed on a personal computer in a conventional manner. The Home Screen (FIG. 3A) is the first screen that appears after the program is started. Referring to FIG. 3A, on upper left, there are two active buttons or fields: “Part I” and “Part 2”. Each of them is a gateway to pre-stored compilations of language units to be covered as a part of a course of study, the general structure of which shall be described further. Other buttons or pull down menus of the Home Screen are conventional.

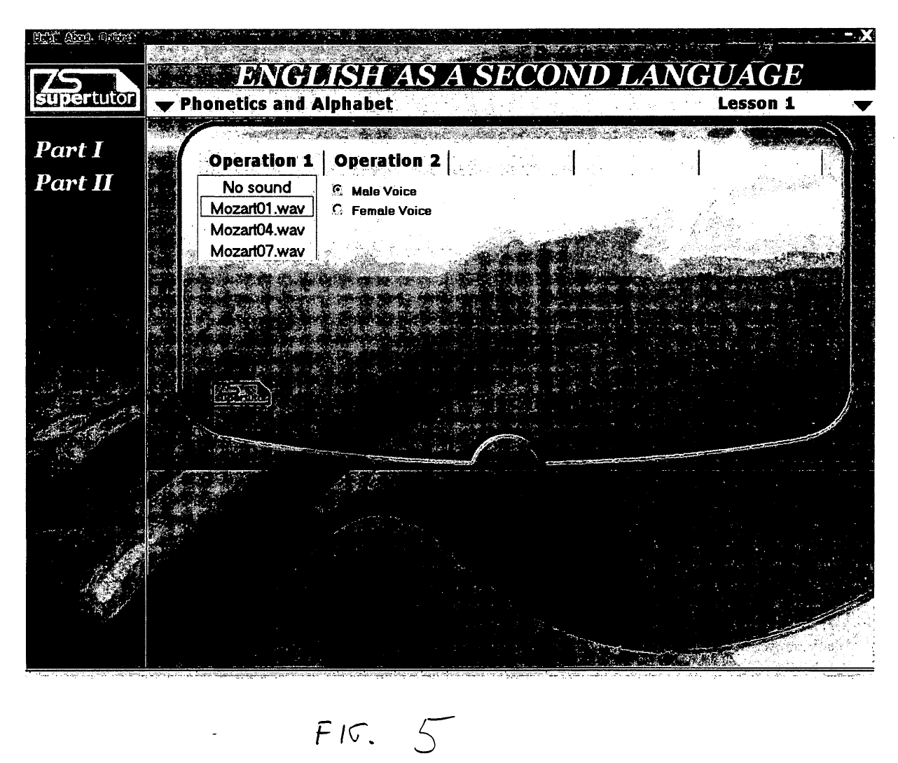

Pressing, for example, the “Part I” button, opens a pull down menu with a list of Lessons included in the Part 1 of the course of study (FIG. 3B). Selecting the desired Lesson from the menu opens a Lesson Screen (FIG. 4). The Lesson Screen is the principal operational screen of ZS Supertutor™. As seen from FIG. 4, the Lesson Screen has a number of active fields or buttons for various Operations included in the lesson.

Briefly describing one possible organization/utilization of ZS Supertutor™, a course of study may include Parts I and II. Of course, larger or smaller number of Parts may be included with ease. Each Part preferably contains 1,500-3,000 language units, alternatively, 1,500-2,000 language units. Each Part includes a number of Lessons (FIG. 3B). A Lesson is one-time performance of all Operations intended for and included in the given Lesson.

Each lesson includes 50-120 language units connected by a given topic; preferably, 70 units. The student goes through lessons in the order on the screen from top to bottom (FIG. 3B). The Part is also divided in sections, each including several Lessons. Each section ends in a Practice lesson designed to firm up the material in the section. The Practice Lesson preferably has only 2 Operations. When the student completes all Lessons in the Part, one course cycle is completed. 3 cycles are expected for each Part.

A Lesson may include two or more Operations, each of which is a separate study platform. As shall be clear from further description, each Operation is self contained and can be started independently by pressing the corresponding button on the Lesson Screen (FIG. 4). Any combination of Operations is contemplated as a separate invention. Nevertheless, the inventors do contemplate a preferred way of using the Operations in the course of study, as shall be shown further.

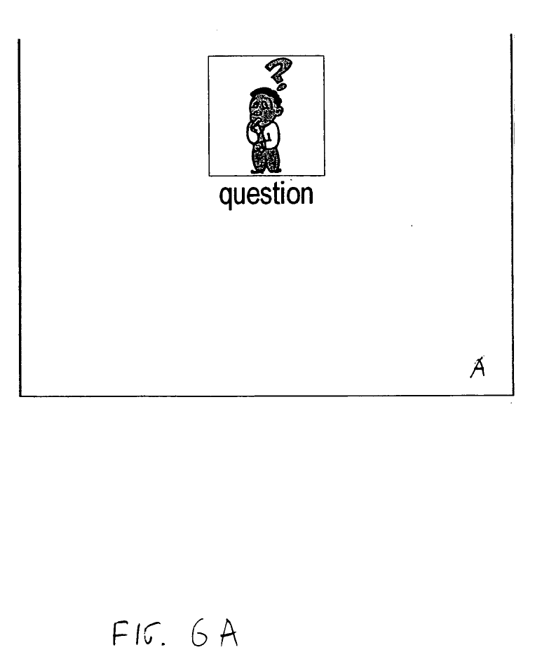

Five general types of Operations are contemplated, and identified herein as “Operation 1,” “Operation 2,” “Operation 3,” “Operation 4,” and “Operation 5.” The numerical values for the Operations do not necessarily indicate the order of use, although the preferred way does involve the use of the Operations in their numerical sequence. Different Lessons may include different number of Operations. For example, Lesson 2 includes Operations 1, 2, 3, 4, and 5 (FIG. 4). Lesson 1, for example, involves only two Operations (FIG. 5).

Operation 1 is designed to “load” the language units into the student's subconsciousness. Pressing “Operation 1” on the Lesson Screen opens a pull-down menu with musical selections (e.g., FIG. 5). It is believed that musical accompaniment can aid in “loading” of the language units into the subconsciousness by activating the student's mind.

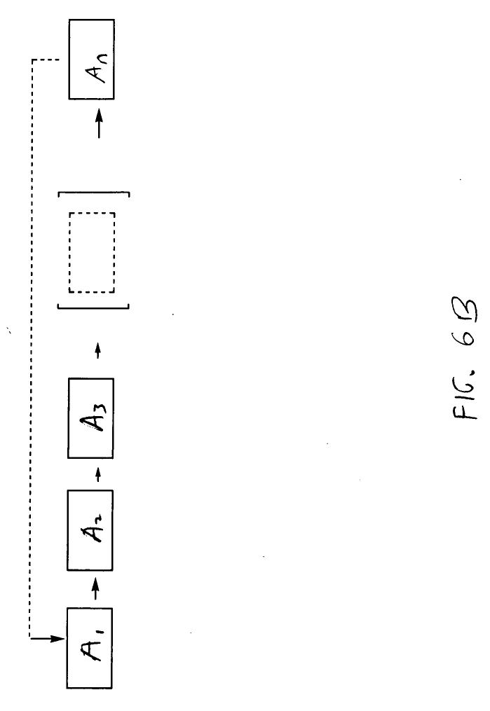

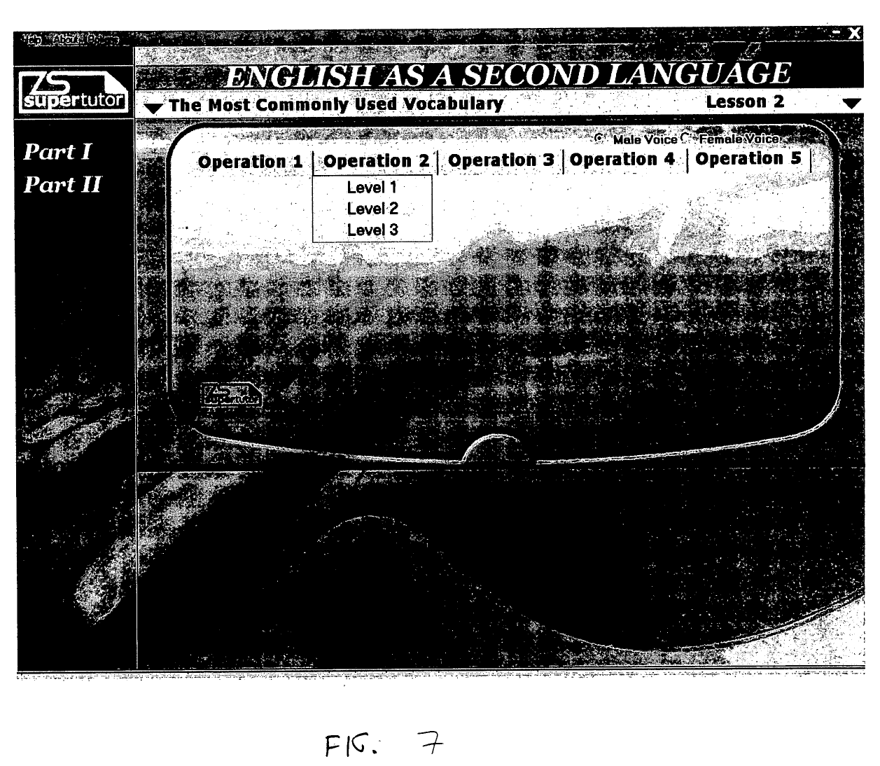

Once the musical accompaniment is selected, the Operation 1 starts immediately. The Operation 1 involves a display of a series of visual cards one after another. The type used in Operation 1 is designated herein as a visual card A. An example of a visual card A is shown in FIG. 6A. The data 110 (FIG. 2) stores one visual card A for each language unit in the Part I, or alternatively, in the Lesson of which the given Operation 1 is a part. As illustrated in FIG. 6A, each of the visual cards A displays a picture depicting a language unit and its text equivalent in English. Again, there is one visual card A for each language unit in the base set (which may be of any size, for example, the Part of the course or the Lesson; the former being preferred). It is contemplated as a variant, although not shown in the attached drawings, that the student may be able to select the quantity of language units shown in Operation 1.

During Operation 1, one visual card A is displayed after another in a series, one visual card A at a time. FIG. 6B illustrates the order of display. With reference to FIG. 6B, the visual card A for language unit 1 is designated as A₁, for language unit 2 as A₂, and so on, until the visual card A for the language unit n is displayed (the card Aₙ). n is the number of language units in the base set (preferably in the Part).

The order and speed of display are pre-determined and stored in the data 110 and/or the instructions 120. Preferably, the speed of display in Operation 1 remains the same during the entire Operation. Generally, the speed of display in Operation 1 is selected to ensure subconscious perception.

It is believed that subconscious perception occurs in Operation 1 when the speed of display is from about 12 to about 25 visual cards per second, preferably, at about 25 cards per second. The entire series of display from the card A₁ to the card Aₙ, or any variation thereof, may be repeated (shown by the dotted arrow). Preferably, the series of same or different visual cards A is in fact repeated 6 to 8 times to ensure sufficient number of repeated exposures of the student's subconsciousness to each visual card A. Preferably, in two repetitions, the entire Part is displayed, whereas the rest of repetitions involve the corresponding section.

In a preferred variant, the length of the entire Operation 1 is about 8 minutes. It should be noted that the later Operations are intended to take up substantially greater time than Operation 1. Once Operation 1 is over, the system returns to the Lesson Screen (FIG. 4)). The instructions 120 will not allow the system to return to Operation 1, in any lesson, until six hours passes since the last Operation 1 was completed.

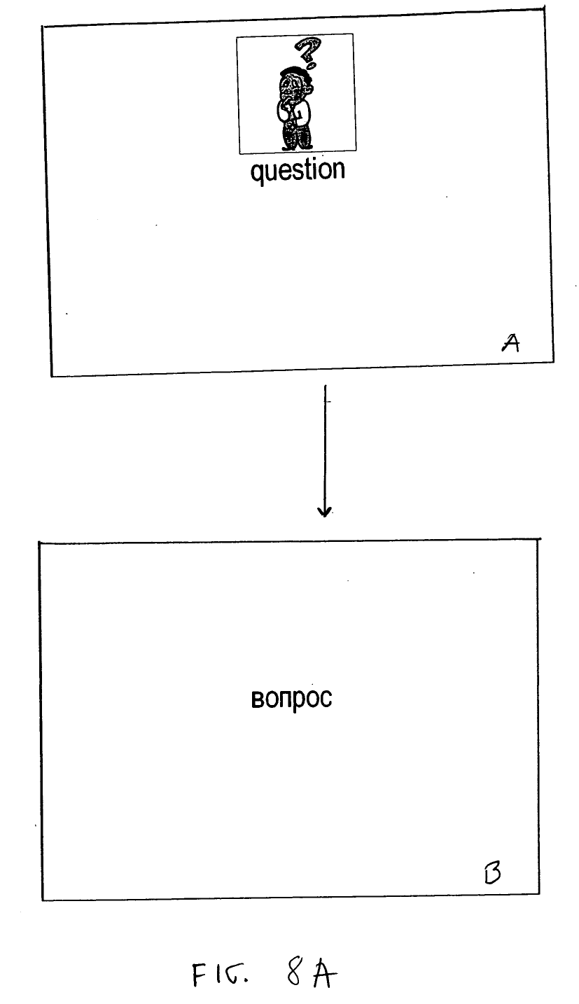

Operation 2 and Operation 3 are designed to “unload” or transpose the “loaded” language units from the student's subconsciousness for conscious memorization, internalization, and use. Pressing “Operation 2” or “Operation 3” on the Lesson Screen opens a pull-down menu with speed of display selections (e.g., FIG. 7). Operations 2 and 3 both display visual cards at pre-set speeds of display that may be chosen by the student. At different stages of learning, the student may need different speeds of display to internalize the language units.

In the particular version of the ZS Supertutor™ illustrated herein, the pre-determined speeds of display for Operations 2 and 3 are 0.6 card/sec, 0.8 card/sec, and 1.2-1.5 cards/sec. These speeds of display are intended to allow conscious perception of the visual cards.

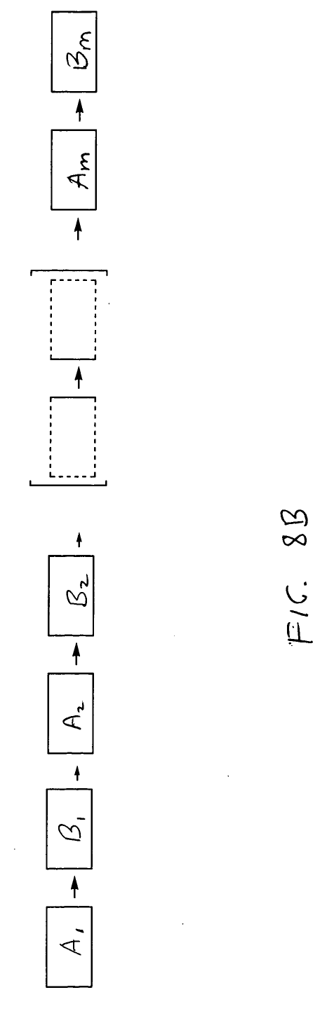

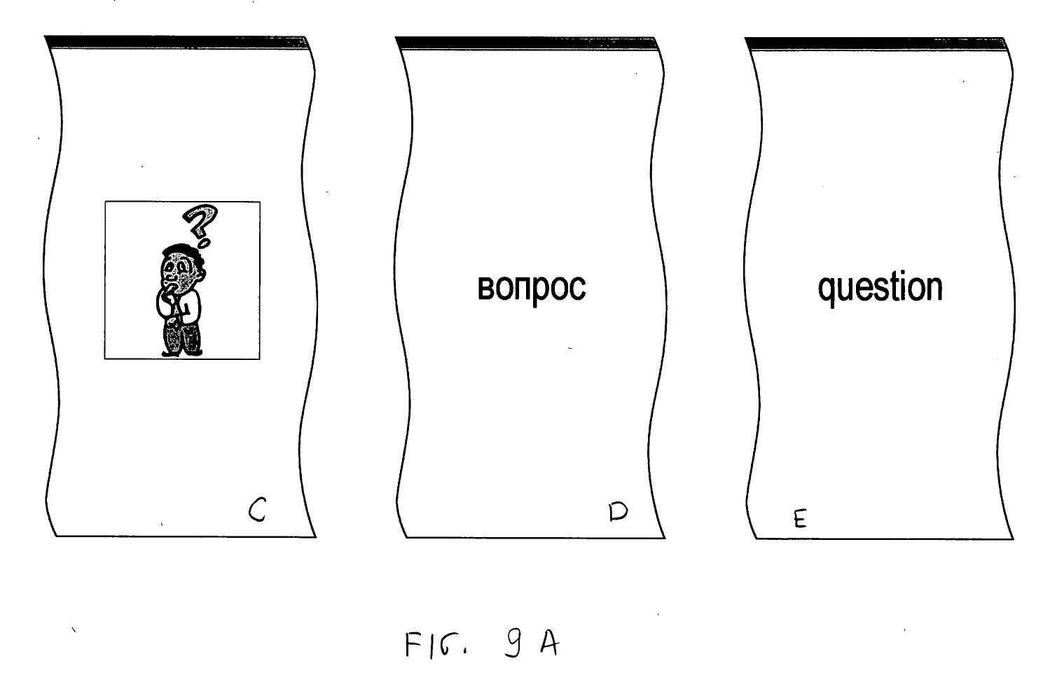

FIG. 8A shows examples of the types of visual cards used in Operation 2. One type of visual cards is the same as in Operation 1 (visual card A). Another (visual card B) depicts the Russian language equivalent for each language unit. Alternatively, visual card B can have the picture along with the Russian language equivalent. Once the speed of display is selected, the Operation 2 starts immediately.

Operation 2 involves a display of another series of visual cards one after another. For each language unit, the data 110 (FIG. 2) stores one visual card A and one visual card B. Preferably, while Operation 1 displays all language units in the Part of the course, Operations 2 and 3 display only the language units included in the particular lesson. It is contemplated as a variant, although not shown in the attached drawings, that the student may be able to select the quantity of language units shown in Operations 2 and 3.

FIG. 8B illustrates the order of display in Operation 2. With reference to FIG. 8B, the visual card A for language unit 1 is designated as A₁, and the visual card B for language unit 1 is designated as B₁. The display of visual cards A and B alternate in this manner until the visual card B for language unit m is displayed (the visual card Bₘ). m is the number of language units in the subset included in Operation 2. The order and speed of display are pre-determined and stored in data 110 and/or instructions 120.

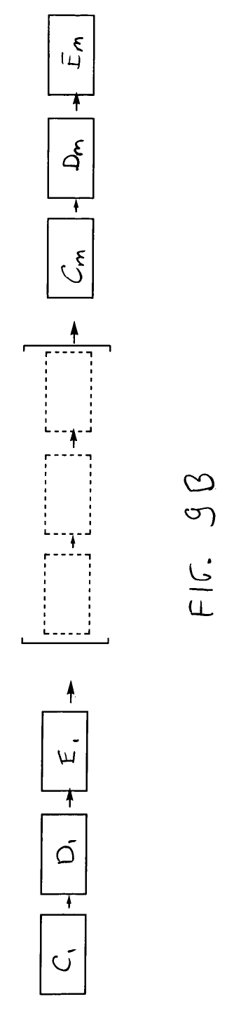

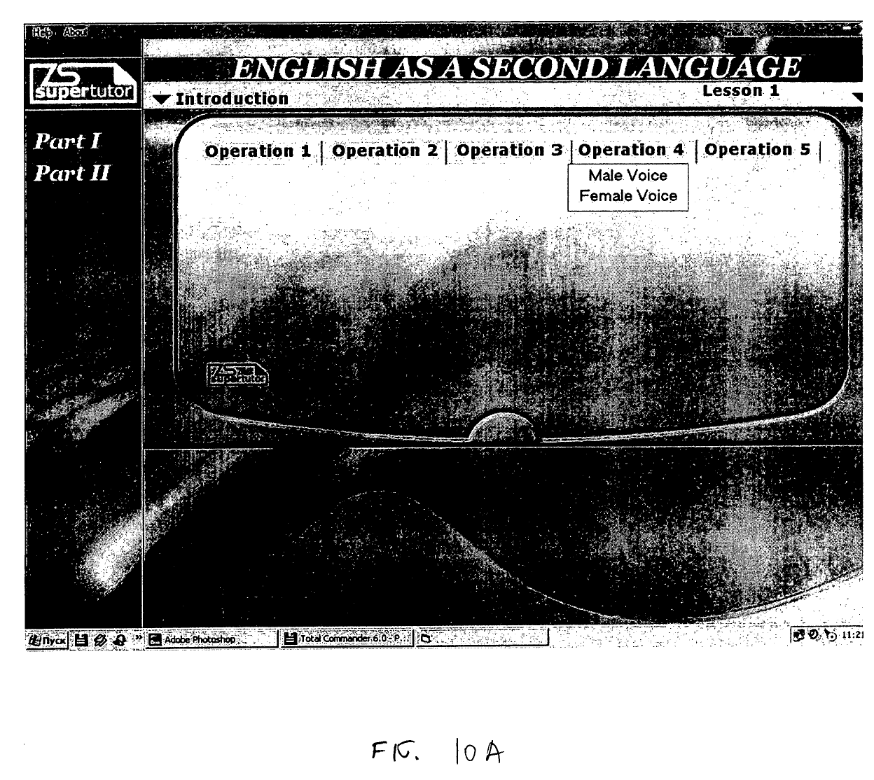

FIG. 9A shows examples of the types of visual cards used in Operation 3. Visual card C depicts a picture for the language unit without its textual equivalent. The visual card D depicts the Russian language textual equivalent. The card D is of the same type as in Operation 2 (visual card B). However, here for convenience and consistency this visual card is designated as D. The visual card E depicts the English language equivalent without the picture.

Once the speed of display is selected, the Operation 3 starts immediately. Operation 3 involves a display of yet another series of visual cards one after another. For each language unit, the data 110 (FIG. 2) stores one visual card C, one visual card D, and one visual card E. FIG. 9B illustrates the order of display in Operation 3.

With reference to FIG. 9B, the visual card C for language unit 1 is designated as C₁, the visual card D for language unit 1 is designated as D₁, and the visual card E for language unit 1 is designated as E₁. The display of visual cards C, D, and E alternate as shown in FIG. 9B until the visual card E for the language unit m is displayed (the card Eₘ). m is the number of language units in the subset included in Operation 3. The order and speed of display are pre-determined and stored in data 110 and/or instructions 120. Alternatively, the Operation 3 may also include visual card F (not shown), which depicts a picture for the language unit together with its Russian equivalent. The order of display in this variant may be, for example, C₁E₁F₁D₁C₂E₂F₂D₂ . . . CₘEₘFₘDₘ. In Operations 2 and 3, the student is expected to associate the picture mentally with the target language in the intervals between the visual cards display.

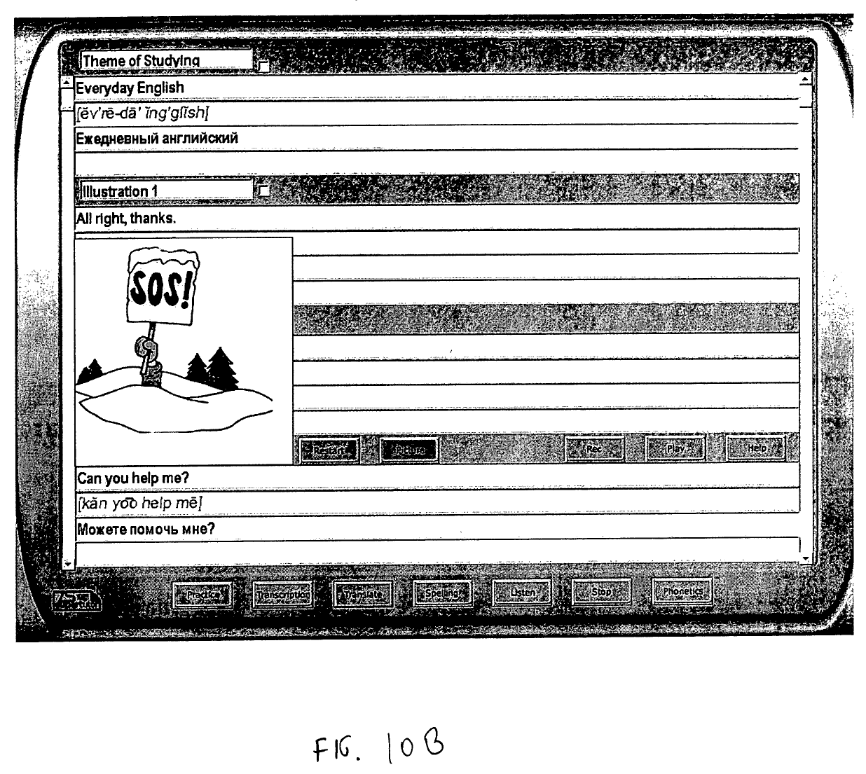

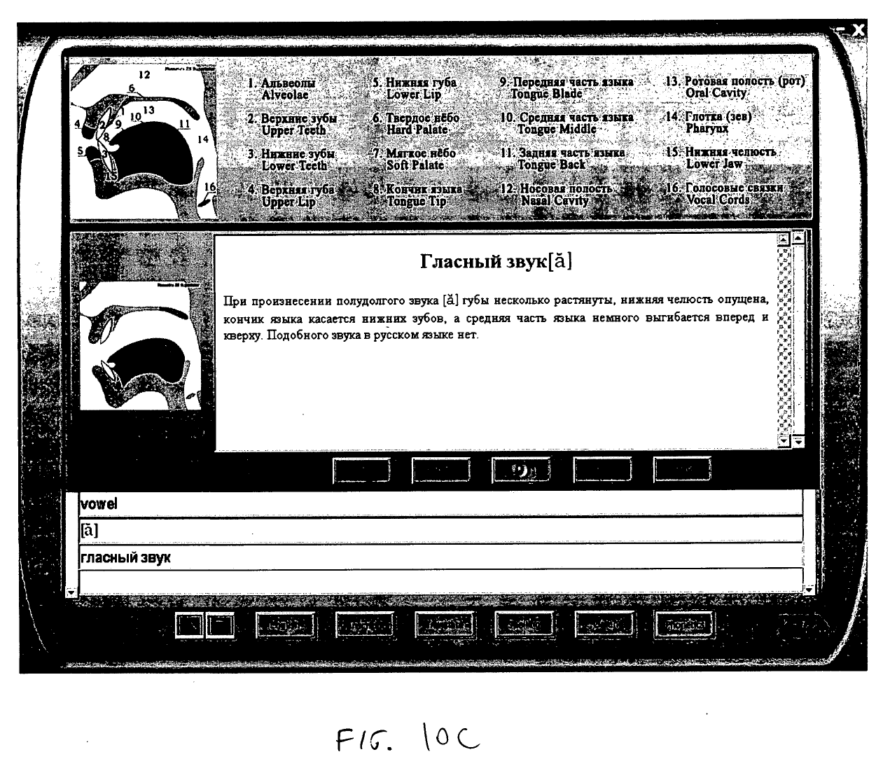

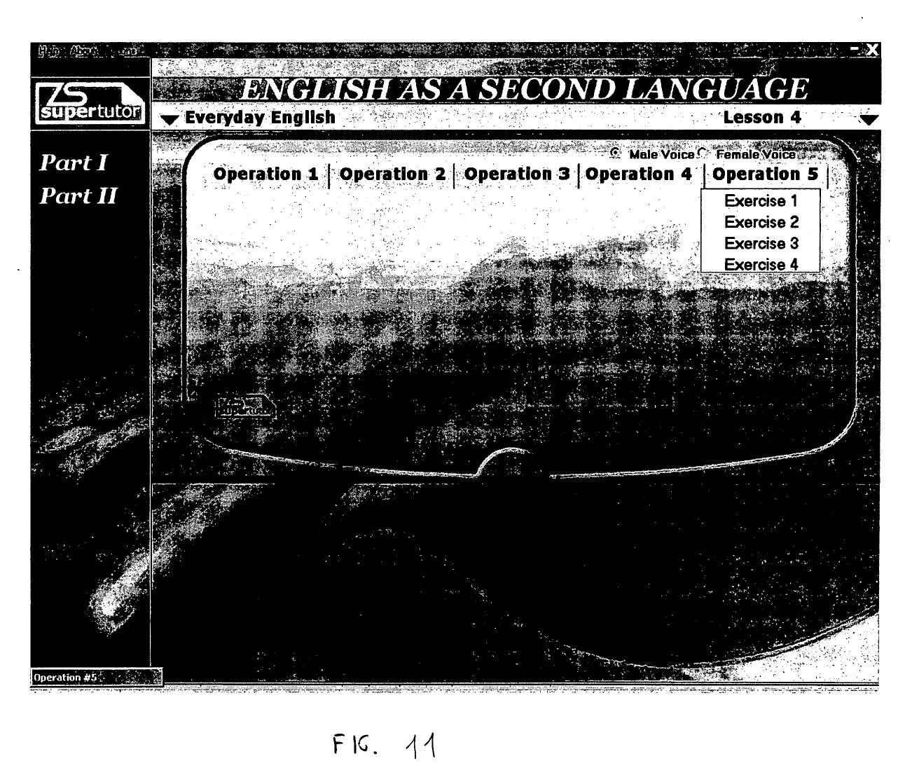

Operation 4 and Operation 5 are designed to help the student to internalize and firm up the language units learnt in prior Operations, as well as to teach the student to use them within the structure of the language. It is preferred that the student uses Operations 4 and 5 after the prior Operations had been displayed; however, the Operations 4 and 5 may be used separately and are contemplated as independent inventions. Pressing “Operation 4” on the Lesson Screen opens a pull-down menu with a selection of male or female voice for the native speaker the recording of which will assist the student (FIG. 10A).

Operation 4 Screen opens (FIG. 10B). It provides a number of manipulations that the student is expected to perform manually. Preferably, Operation 4 involves the same language units that were studied in Operations 2 and 3. The following is the description of the buttons available in the Operation 4 Screen (FIG. 10B). “Picture” brings up a picture associated with one of the language units studied in Operations 2 and 3 of the same Lesson. The student mentally considers the picture and tries to recall its English equivalent. To check the recollection, the student can press “Practice” that will place the English text equivalent into the corresponding line under the picture. The student can check the transcription of the English text by pressing “Transcription.” If the student remains unsure, the Russian language equivalent can be brought up by pressing “Translate.” To check the student's ability to spell the English text, the student can press “Spelling” so that a line opens to allow the student to type in the text, and then compare it with the proper spelling by pressing “Practice.” To train the student's audio perception of the language, several audio buttons are available. The student can press “Rec” to activate the microphone 47 and record the English equivalent at any time. The student may press “Play” to re-play his/her recording and press “Listen” to hear a native speaker's pronunciation of the same language unit. Preferably, the student is instructed to first play the audio with the native speaker's pronunciation of the same language unit, and then record his/her own pronunciation. The audio may be stopped at any time by pressing “Stop.” The Operation 4 Screen has a separate module for illustrating and guiding proper pronunciation techniques. Pressing “Phonetics” opens a separate screen that has instructions and exercises for pronunciation training (FIG. 10C).

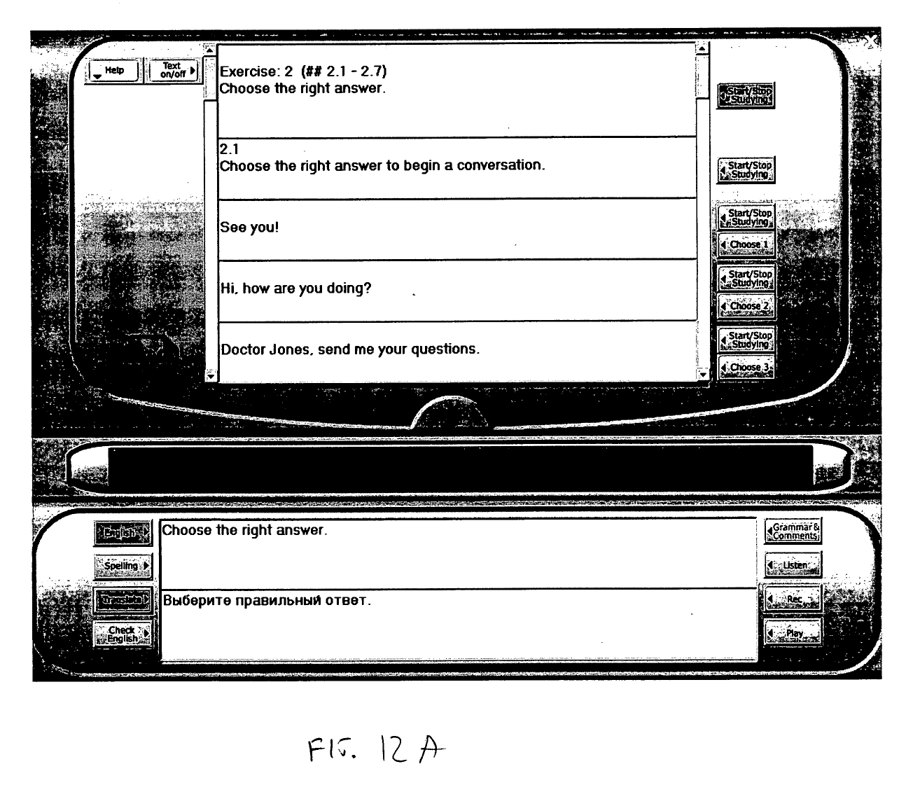

Pressing “Operation 5” on the Lesson Screen opens a pull-down menu with a selection of exercises (FIG. 11). Preferably, Operation 5 involves the language units studied in operations 2, 3, and 4, as well as additional language units that belong to passive vocabulary. The use of such passive vocabulary units without exposure to them in Operations 2, 3, and 4 is designed to extend the student command and internalization of the language as a whole.

Operation 5 may include a number of various exercises that involve the language units in the active vocabulary (i.e., those studied in Operations 2, 3, and 4) as well as the passive vocabulary.

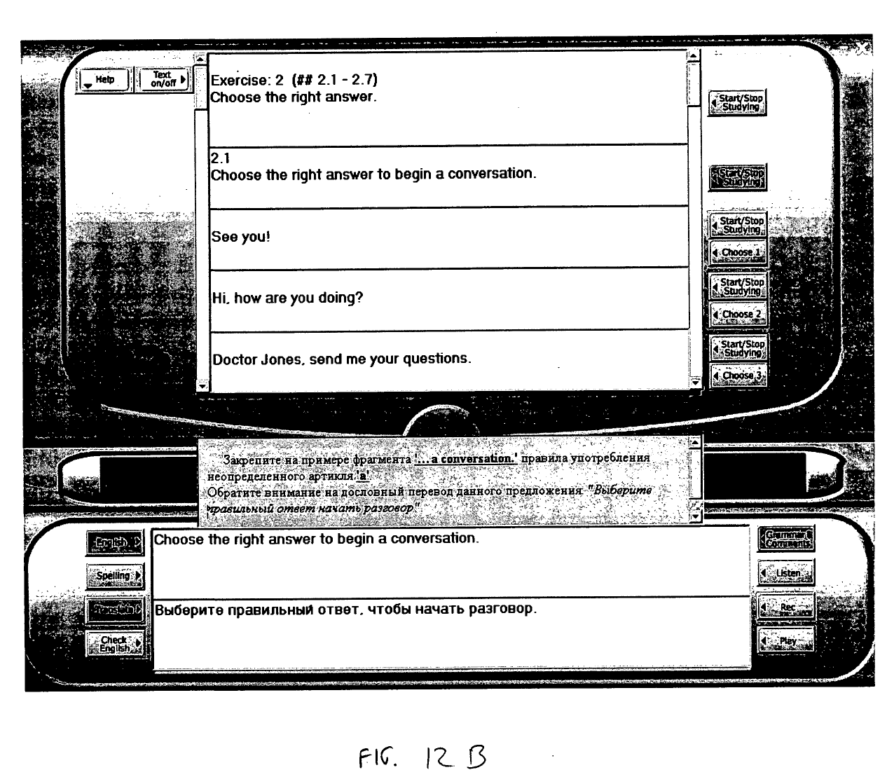

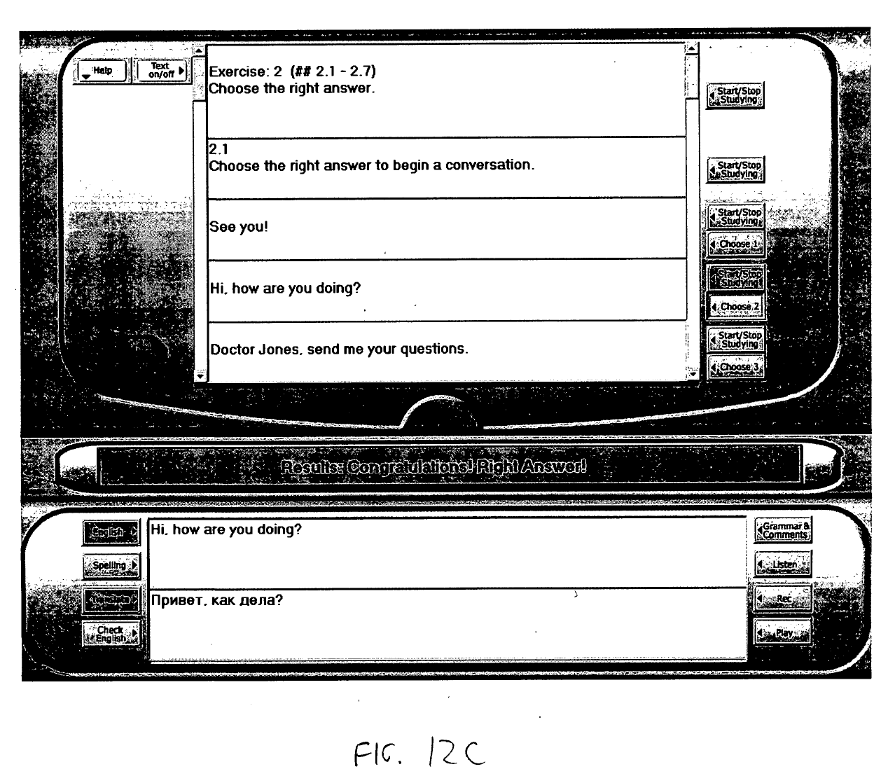

FIGS. 12A-12B illustrate one of many exercises that may be included in Operation 5. Referring to FIG. 12A, similarly to the Operation 4 Screen, a number of buttons are provided to permit various inputs via keyboard 43, pointing device 45, and microphone 47. The exercise illustrated in FIGS. 12A-12C provides the student with an opportunity to choose the answer from several choices, to translate the English text of the exercise into Russian, to type/spell the answers via the keyboard, to check the correctness of the English spelling by the student, to obtain comments on Grammar via the separate “Grammar/Comments” button, to be informed whether the answer the student had provided is correct and, if no, why (FIG. 12B).

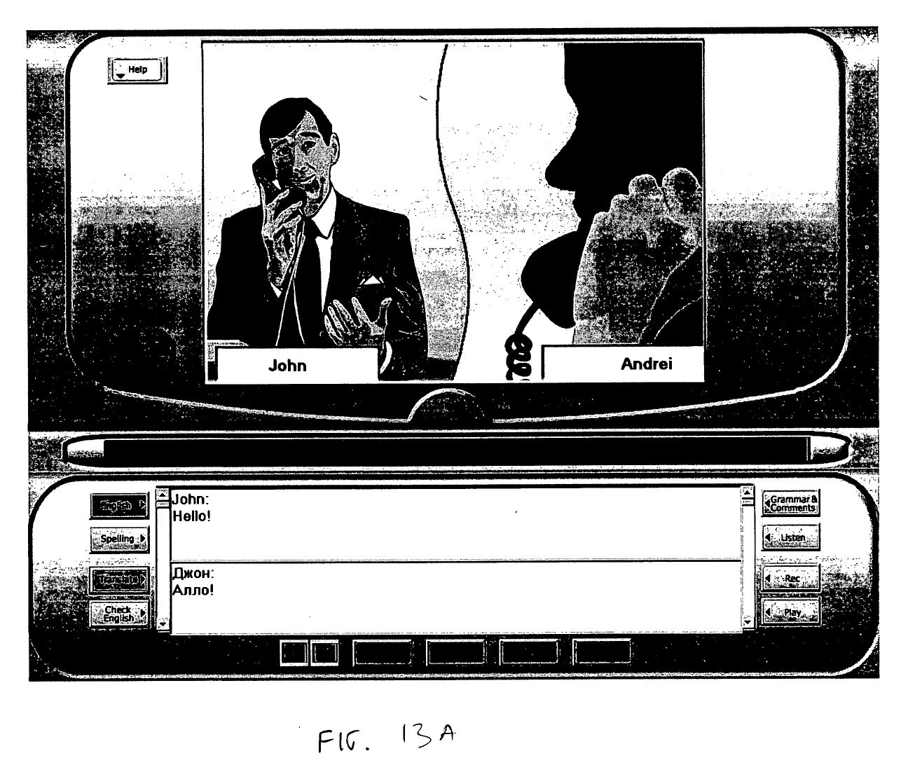

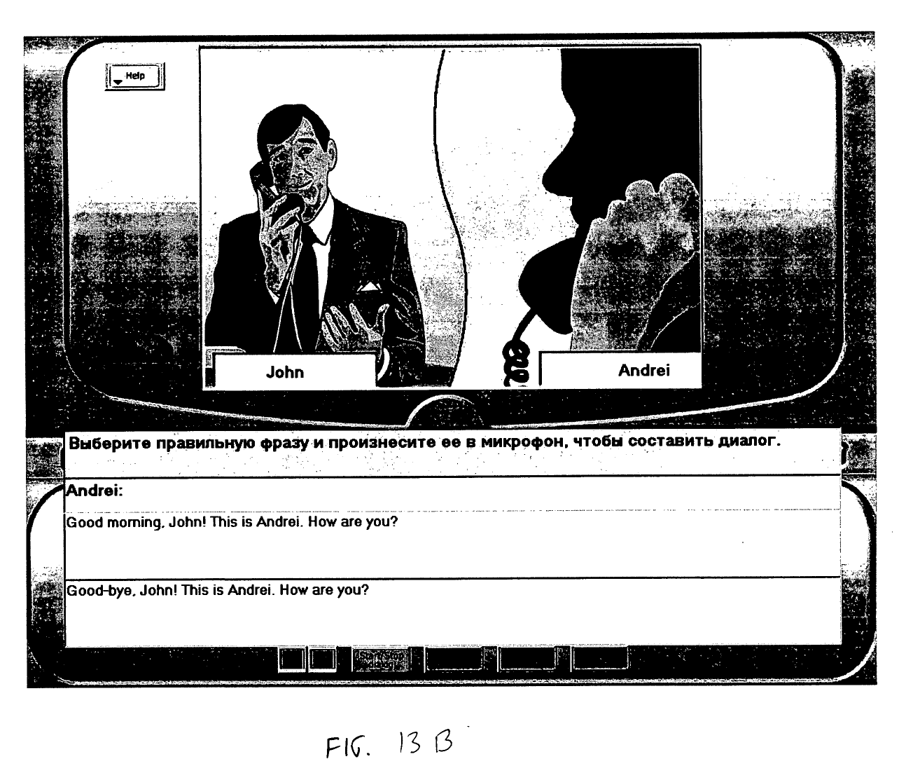

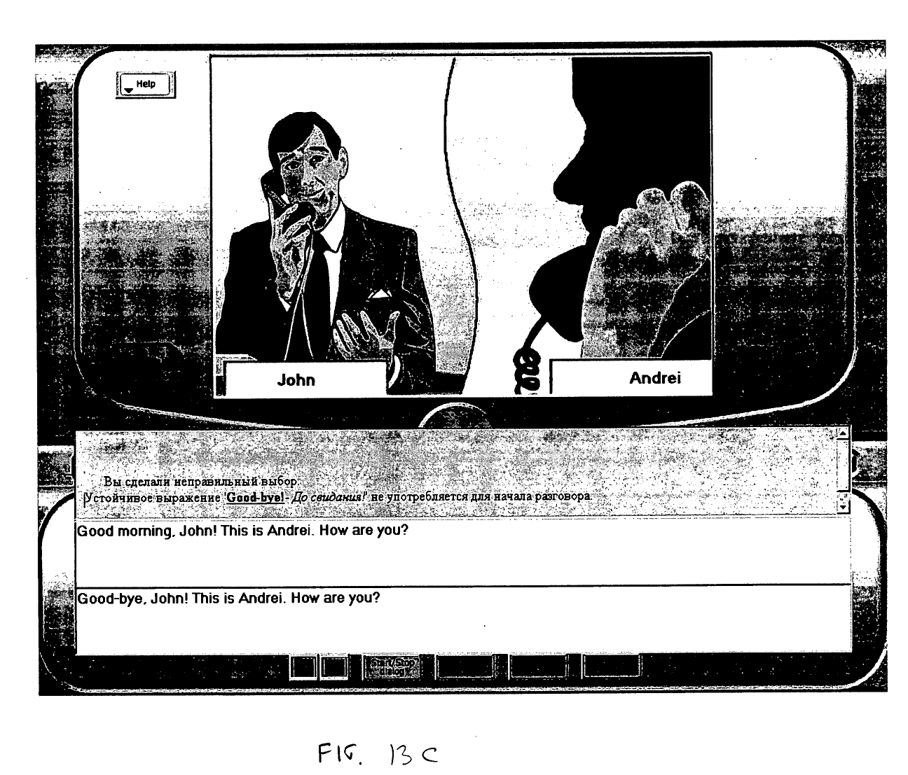

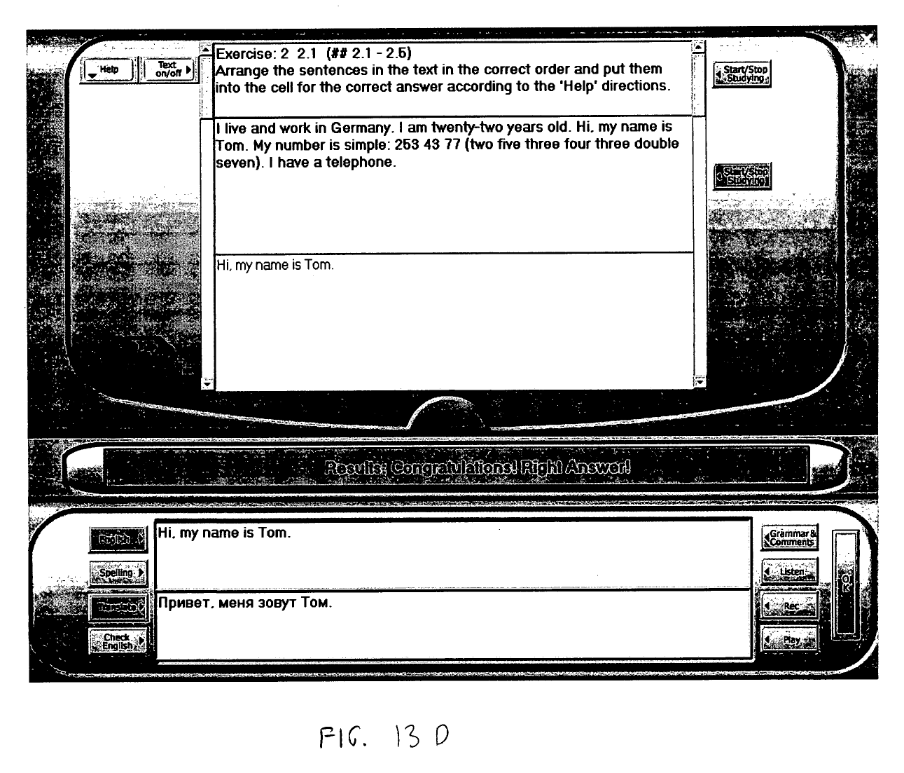

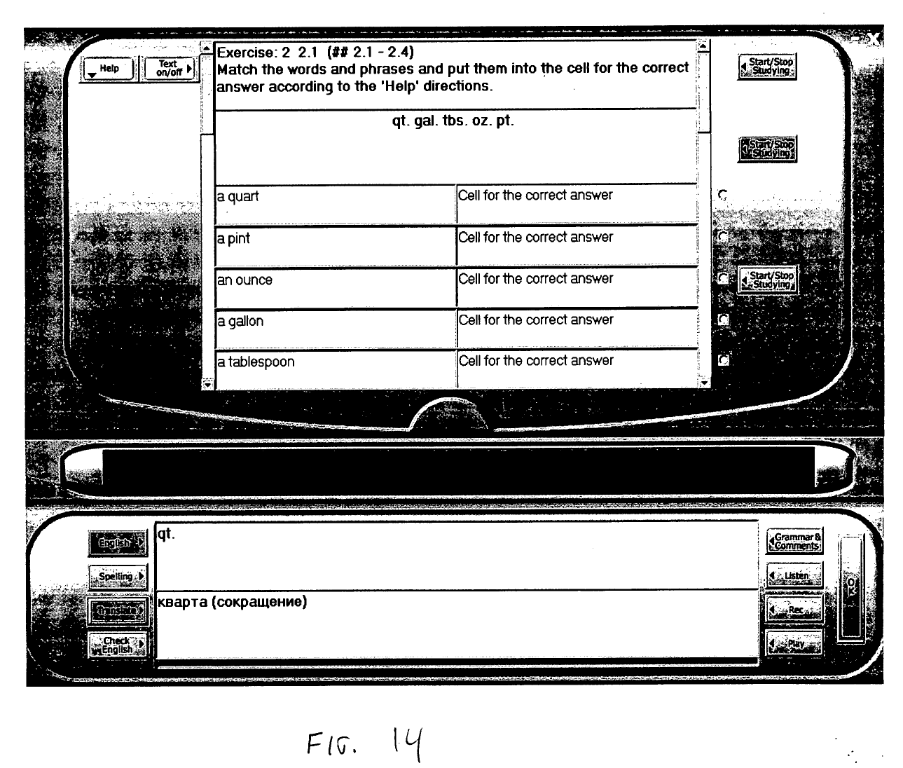

The exercise illustrated in FIGS. 13A-13D imitates a conversation between a native English speaker and the student learning the English language. It provides for a number of manipulations that the student performs manually, several of them similar to the manipulations in Operation 4. The particularly interesting feature of this exercise involves imitated audio conversation between the English speaker and the student leaning English. The button “Start/Stop” dialog activates the native speaker voice and prompts the student to respond. The dialog can be recorded, re-played, etc. in the same manner as in Operation 4. If the student makes an error, the student is informed of the nature of the error (FIG. 13C). The correctness of the answer is also indicated (FIG. 13D). FIG. 14 illustrates a word-matching exercise.

The invention has a number of attractive features. Thus, in any mode of implementation and especially as implemented on a personal computer platform, the method of the invention is suitable for and especially useful for self-study of language. Likewise, various devices described above allow the student to control the progress of the study. It also allows students at different levels or ability to adjust his/her study program accordingly.

Importantly, the method greatly simplifies language study in comparison with traditional translation methodologies. The language is learned naturally and easily; the required effort is minimized.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for teaching a target of instruction to a person, said method comprising:
a) exposing said person to at least one language unit in a mode of exposure intended for subconscious perception, wherein said person is simultaneously exposed to a pictorial representation of the language unit and its language equivalent; and
b) subsequently exposing said person to said language unit in a mode of exposure intended for conscious perception.

2. The method of claim 1, wherein said step b) includes exposing said person to said pictorial representation of said language unit.

3. The method of claim 2, wherein said step b) further includes exposing said person to said language equivalent of said language unit.

4. The method of claim 3, wherein said step a) includes exposing said person to at least one base set of language units.

5. The method of claim 4, wherein said step a) includes exposing said person to one language unit after another.

6. The method of claim 5, wherein said step a) includes exposing said person to one language unit at a time.

7. The method of claim 6, wherein said step b) includes exposing said person to a subset of said at least one base set of language units.

8. The method of claim 7, wherein said step b) includes exposing said person to said subset one language unit after another at a speed intended for said conscious perception.

9. The method of claim 8, wherein said step b) includes exposing said person to one language unit at a time.

10. The method of claim 7, wherein the number of language units in said subset is smaller than the number of language units in said base set.

11. The method of claim 1, wherein said language equivalent is in audio form.

12. The method of claim 1, wherein said language equivalent is in a visual form.

13. The method of claim 12, wherein said visual form of said language equivalent is a textual representation of the language unit.

14. The method of claim 13, wherein said textual representation is selected from the group consisting of a word, a sentence, and an expression.

15. The method of claim 1, which is implemented in a computer system.

16. The method of claim 4, wherein said base set includes between about 1,500 to about 3,000 language units.

17. The method of claim 16, wherein said base set includes between about 1,500 to about 2,000 language units.

18. The method of claim 7, wherein said subset includes between about 50 and about 150 language units.

19. The method of claim 18, wherein said subset includes about 70 language units.

20. The method of claim 1, wherein said target of instruction is a target language.

21. A method for teaching a target language of instruction to a person having a home language, said method comprising:
a. exposing said person to at least one base set of language units in a mode of exposure intended for subconscious perception, wherein, for each language unit in said base set, said person is simultaneously exposed to a pictorial representation of the language unit and its language equivalent in the target language; and
b. subsequently exposing said person to said pictorial representation of the language unit and its language equivalent in the home language in a mode of exposure intended for conscious perception.

22. The method of claim 21, wherein said step a) includes displaying to said person a first series of visual cards one after another, one visual card for each language unit in said base set, each visual card simultaneously displaying the pictorial representation of the language unit and its language equivalent in the target language.

23. The method of claim 22, wherein said step a) includes exposing said person to the entire base set of language units displayed on said visual cards before said step b).

24. The method of claim 23, wherein said step b) includes exposing said person to a subset of said at least one base set of language units.

25. The method of claim 24, wherein said step b) includes displaying to said person a second series of visual cards one after another, said second series containing representations for the language units in said subset;
wherein, for each language unit in said subset, said second series includes i) a first visual card simultaneously displaying the pictorial representation of the language unit and its textual representation in the target language; and ii) a second visual card displaying at least the textual representation of the language unit in the home language.

26. The method of claim 25, wherein said step b) further comprises displaying to said person a third series of visual cards one after another after said second series is displayed, said third series containing representations for the language units in said subset;
wherein, for each language unit in said subset, said third series includes iii) a third visual card displaying at least the pictorial representation of the language unit, iv) a forth visual card displaying at least the textual representation of the language unit in the home language; v) a fifth visual card displaying at least the textual representation of the language unit in the target language.

27. The method of claim 26, wherein said third series includes the following order of display for each language unit: the third visual card, followed by the forth visual card, followed by the fifth visual card.

28. The method of claim 21, wherein said step b) includes providing said person with at least one exercise that comprises static display of said pictorial representation.

29. The method of claim 28, wherein said exercise further comprises providing said person with means to translate said statically displayed pictorial representation into its target language equivalent.

30. The method of claim 28, wherein said exercise further comprises providing said person with means to translate said statically displayed pictorial representation into its home language equivalent.

31. The method of claim 28, wherein said exercise further comprises providing said person with means to record an audio form of the target language equivalent of said statically displayed pictorial representation.

32. The method of claim 28, wherein said exercise further comprises providing said person with means to play an audio form of the target language equivalent of said statically displayed pictorial representation pronounced by a native speaker.

33. The method of claim 28, wherein said exercise further comprises providing said person with means to display a transcription of the target language equivalent of said statically displayed pictorial representation.

34. The method of claim 28, wherein said exercise further comprises providing said person with means to type the target language equivalent of said statically displayed pictorial representation.

35. The method of claim 25, wherein said first visual cards and said second visual cards alternate with one another in said second series.

36. The method of claim 35, wherein, in said second series, a second visual card is displayed following the display of a first visual card for the same language unit.

37. The method of claim 36, wherein said second series of visual cards includes representations for all language units in said subset.

38. The method of claim 37, wherein each of said second visual cards in said second series further displays the same pictorial representation as displayed in the preceding first visual card.

39. The method of claim 23, wherein said step a) includes repeating said display of the entire base set of language unit on said visual cards for a pre-determined plurality of times.

40. The method of claim 39, wherein said pre-determined plurality is 6 to 8 times.

41. The method of claim 25, wherein said first visual cards are identical to the visual cards displayed in said first series.

42. The method of claim 22, wherein the speed of display of said first series of visual cards is predetermined to achieve said subconscious perception.

43. The method of claim 42, wherein said predetermined speed of display is ranging from about 12 visual cards per second to about 25 visual cards per second.

44. The method of claim 21, wherein said target language is different from said home language.

45. The method of claim 21, wherein said person is not simultaneously exposed to a language unit in the target language and in the home language.

46. The method of claim 22, wherein said visual cards are displayed on a display device.

47. The method of claim 46, wherein said display device is a computer monitor.

48. The method of claim 21, wherein said home language is English.

49. The method of claim 21, wherein said target language is English.

50. The method of claim 21, wherein said step a) further comprises exposing said person to a musical accompaniment to aid said subconscious perception.

51. The method of claim 50, wherein said musical accompaniment is carried out simultaneously with said display of said first series of visual cards.

52. In a computer system, a method for teaching a target of instruction to a person, said method comprising:
i) presenting the person with static display of a pictorial representation of a language unit thus communicating a challenge that requires said person to translate said pictorial representation into its language equivalent;
ii) receiving said translation from the person in response to the challenge; and
iii) providing the person with means to ascertain whether the person comprehended the challenge.

53. The method of claim 52, wherein said step ii) includes receiving a textual representation of said language unit.

54. The method of claim 52, wherein said step ii) includes receiving an audio representation of said language unit.

55. The method of claim 52, wherein said step iii) includes providing a transcription of a textual representation of said language unit.

56. The method of claim 52, wherein said step iii) includes playing a pre-recorded audio of the language equivalent of said language unit.

57. The method of claim 52, wherein said step iii) includes automatically providing information to the person to indicate whether the person's translation had been correct.

58. The method of claim 52, wherein said target of instruction is a target language.

59. The method of claim 58, wherein said step ii) includes receiving a textual representation of the target language equivalent of the language unit.

60. The method of claim 58, wherein said step iii) includes providing a textual representation of the home language equivalent of the language unit.

61. A computer readable memory medium containing instructions for controlling the operation of a computer processor in a computer system for teaching a target of instruction to a person, said computer system including a display device, said computer system having
a) stored data of a first series of visual cards, one visual card for each language unit that belongs to at least one base set of language units, wherein each of said visual cards contains a pictorial representation of the language unit and its language equivalent;
b) stored data of a second series of visual cards, at least one for each language unit that belongs to at least one subset of said base set of language units, wherein said second series contains at least the pictorial representation of the language unit; and
c) instructions for controlling the operation of said computer processor to perform the steps of:
i) retrieving the stored data of said first series of visual cards;
ii) displaying said first series of visual cards one after another in a predetermined sequence on said display device at a speed intended for subconscious perception by said person;
iii) retrieving the stored data of said second series of visual cards; and
iv) displaying said second series of visual cards one after another in a second predetermined sequence on said display device at a speed intended for conscious perception by said person.

62. The computer readable memory medium of claim 61, wherein said language equivalents are textual representations of the language units.

63. The computer readable memory medium of claim 62, wherein said first series of visual cards is displayed one after another, one visual card for each language unit in said base set, each visual card simultaneously displaying the pictorial representation and the textual representation of the same language unit.

64. The computer readable memory medium of claim 63, wherein said computer system further includes stored data of a musical recording, the instructions for controlling the operation of said computer processor to perform the further step of playing said musical recording to aid said subconscious perception.

65. The computer readable memory medium of claim 64, wherein said step of playing said musical recording is carried out simultaneously with said display of said first series of visual cards.

66. The computer readable memory medium of claim 65, wherein the speed of display of said first series of visual cards is predetermined to achieve said subconscious perception.

67. The computer readable memory medium of claim 66, wherein said predetermined speed of display of said first series of visual cards is ranging from about 12 visual cards per second to about 25 visual cards per second.

68. The computer readable memory medium of claim 67, wherein said step ii) includes exposing said person to the entire base of set of language units displayed on said visual cards.

69. The computer readable memory medium of claim 68, wherein said step ii) includes repeating said display of the entire base of set of language unit on said visual cards for a pre-determined plurality of times.

70. The computer readable memory medium of claim 69, wherein said target of instruction is a target language of instruction.

71. The computer readable memory medium of claim 70, wherein said step iv) includes displaying to said person said second series of visual cards one after another, said second series containing representations for the language units in said subset;
wherein, for each language unit in said subset, said second series includes i) a first visual card simultaneously displaying the pictorial representation of the language unit and its textual representation in the target language; and ii) a second visual card displaying at least the textual representation of the language unit in the home language of said person.

72. The computer readable memory medium of claim 71, wherein said first visual cards are identical to the visual cards displayed in said first series.

73. The computer readable memory medium of claim 72, wherein said first visual cards and said second visual cards alternate with one another.

74. The computer readable memory medium of claim 73, wherein, in said second series, a second visual card is displayed following the display of a first visual card for the same language unit.

75. The computer readable memory medium of claim 74, wherein said second series of visual cards includes representations for all language units in said subset.

76. The computer readable memory medium of claim 75, wherein each of said second visual cards in said second series further displays the same pictorial representation as displayed in the preceding first visual card.

77. The computer readable memory medium of claim 74, wherein said computer system further includes stored data of third series of visual cards, wherein said visual cards of said third series are intended for display to said person;
wherein, for each language unit in said subset, said third series includes a third visual card displaying at least the pictorial representation of the language unit, a forth visual card displaying at least the textual representation of the language unit in the home language, and a fifth visual card displaying at least the textual representation of the language unit in the target language;
the instructions controlling the operation of said computer processor to perform the further step of displaying said third series of visual cards to said person one after another after said second series is displayed.

78. The computer readable memory medium of claim 77, wherein the instructions control the operation of said computer processor to cause it to display said third series of visual cards in the following order of display for each language unit: the third visual card, followed by the forth visual card, followed by the fifth visual card.

79. The computer readable memory medium of claim 61, wherein said computer system is on a personal computer.

80. The computer readable memory medium of claim 61, wherein said display device is a computer monitor.

81. The computer readable memory medium of claim 62, wherein said base set includes between about 1,500 to about 2,000 language units.

82. The computer readable memory medium of claim 62, wherein said subset includes between about 50 and about 150 language units.

83. The computer readable memory medium of claim 82, wherein said subset includes about 70 language units.

84. The computer readable memory medium of claim 66, wherein said textual representation is selected from the group consisting of a word, a sentence, and an expression.

85. The computer readable memory medium of claim 61, wherein said home language is English.

86. The computer readable memory medium of claim 61, wherein said target language is English.

87. A computer system having the computer readable memory medium of claim 61.
